(19) United States
(12) Patent Application Publication
(10) Pub. No.: US 2008/0166646 A1
(43) Pub. Date: Jul. 10, 2008

(54) TONER FOR REDUCED PHOTORECEPTOR WEAR RATE

(75) Inventors: Karen A. MOFFAT, Brantford (CA); Jorge A. ALVAREZ, Webster, NY (US); William H. HOLLENBAUGH, Rochester, NY (US); James M. CHAPPELL, Webster, NY (US); Gregory D. GERBASI, Webster, NY (US)

Correspondence Address: OLIFF & BERRIDGE, PLC., P.O. BOX 320850, ALEXANDRIA, VA, 22320-4850, US

(73) Assignee: Xerox Corporation, Stamford, CT (US)

(21) Appl. No.: 11/623,469

(22) Filed: Jan. 16, 2007

Related U.S. Application Data
(60) Provisional application No. 60/863,579, filed on Oct. 31, 2006.

(51) Int. Cl. G03G 9/00

(52) U.S. Cl. 430/108.1

(57) ABSTRACT

An electrophotographic image forming apparatus comprising a photoreceptor, a conductive magnetic brush development system, and a housing in association with the conductive magnetic brush development system for a developer comprising a toner composition having emulsion/aggregation toner particles comprising a gel latex, a high Tg latex, a wax, and a colorant, wherein the wear rate of the photoreceptor is improved.

### CROSS-REFERENCE TO RELATED APPLICATION

This nonprovisional application claims the benefit of U.S. Provisional Application No. 60/863,579, filed Oct. 31, 2006.

### BACKGROUND

Disclosed herein is a development system having a photoreceptor and an emulsion/aggretion toner comprising a gel latex, a high Tg latex, a wax, and a colorant, wherein the toner particles improve the wear rate of a photoreceptor in a development system.

### REFERENCES

U.S. Publication No. 2006-0121384 to Patel, which is incorporated herein in its entirety by reference, discloses toner compositions and processes, such as emulsion aggregation toner processes, for preparing toner compositions comprising a resin substantially free of crosslinking, a crosslinked resin, a wax and a colorant.

U.S. patent application Ser. No. 11/272,720 to Patel et al., which is incorporated herein in its entirety by reference, is directed to toner compositions and processes, such as emulsion aggregation toner processes, for preparing toner compositions comprising a high molecular weight non-crosslinked resin such as having a weight average molecular weight of at least 50,000, a wax, and a colorant.

It is still desired to improve the components and design parameters of EA toner that may reduce the photoreceptor wear rate and provide photoreceptor life enhancement.

### SUMMARY

In embodiments, disclosed is an electrophotographic image forming apparatus comprising a photoreceptor, a conductive magnetic brush development system, and a housing in association with the conductive magnetic brush development system for a developer comprising a toner composition having emulsion/aggregation toner particles comprising a gel latex, a high Tg latex, a wax, and a colorant, wherein the gel latex is present in an amount of from about 3 weight percent to about 30 weight percent of the toner composition, the high Tg latex is present in an amount of from about 50 weight percent to about 95 weight percent of the toner composition, the wax is present in an amount of from about 2 weight percent to about 40 weight percent of the toner composition, and the colorant is present in an amount of from about 1 weight percent to about 25 weight percent of the toner composition.

In further embodiments, disclosed is a developer comprising a carrier and an emulsion/aggregation toner, wherein the toner comprises a gel latex, a high Tg latex, a wax, and a colorant, wherein the gel latex is present in an amount of from about 3 weight percent to about 30 weight percent of the toner, the high Tg latex is present in an amount of from about 50 weight percent to about 95 weight percent of the toner, the wax is present in an amount of from about 2 weight percent to about 40 weight percent of the toner, and the colorant is present in an amount of from about 1 weight percent to about 25 weight percent of the toner.

In yet further embodiments, disclosed is a method of printing a toner based image, comprising charging a photoreceptor to a uniform potential, exposing the charged photoreceptor surface to a light image in order to record an electrostatic latent image onto the surface of the photoreceptor, developing the electrostatic latent image by bringing a developer in contact with the electrostatic latent image to expose an image, transferring the image to a substrate to form a toner-based image, and fusing the toner-based image to the substrate, wherein the developer comprises an emulsion/aggregation, toner having a gel latex, a high Tg latex, a wax, and a colorant, wherein residual toner is removed from the photoreceptor with a cleaning device, and wherein the wear rate of the photoreceptor is from about −0.004 μm/Kcycles to about −0.018 μm/Kcycles.

### Embodiments

Generally, the process of electrophotographic printing includes charging a photoconductive member to a substantially uniform potential to sensitize the surface thereof. The charged portion of the photoconductive surface is exposed to a light image from, for example, a scanning laser beam, an LED source, etc., or an original document being reproduced. This records an electrostatic latent image on the photoconductive surface of the photoreceptor. After the electrostatic latent image is recorded on the photoconductive surface, the latent image is developed by bringing a developer comprised of toner into contact therewith.

Two component and single component developer materials are commonly used. A typical two-component developer material comprises magnetic carriers having toner particles adhering triboelectrically thereto. A single component developer material typically comprises toner particles. Toner particles are attracted to the latent image forming a toner powder image on the photoconductive surface. The toner powder image is subsequently transferred to a substrate, such as paper or a copy sheet. Finally, the toner powder image is heated to permanently fuse it to the copy sheet in image configuration.

A known way of developing the latent image on the photoreceptor is by use of one or more magnetic brushes. See, for example, U.S. Pat. Nos. 5,416,566, 5,345,298, 4,155,329 and 3,981,272, each of which is incorporated herein by reference in their entireties.

In embodiments, conductive magnetic brush (CMB) developers can be selected for hybrid jumping development, hybrid scavengeless development, and similar processes, reference U.S. Pat. Nos. 4,868,600; 5,010,367; 5,031,570; 5,119,147; 5,144,371; 5,172,170; 5,300,992; 5,311,258; 5,212,037; 4,984,019; 5,032,872; 5,134,442; 5,153,647; 5,153,648; 5,206,693; 5,245,392; 5,253,016, the disclosures of which are totally incorporated herein by reference in their entireties.

The aforementioned developers, which can contain a negatively charging toner, are suitable for use with laser or LED printers, discharge area development with layered flexible photoconductive imaging members, reference U.S. Pat. No. 4,265,990, the disclosure of which is totally incorporated herein by reference, and organic photoconductive imaging members with a photogenerating layer and a charge transport layer on a drum, light lens xerography, charged area development on, for example, inorganic photoconductive members such as selenium, selenium alloys like selenium, arsenic, tellurium, hydrogenated amorphous silicon, trilevel xerography, reference U.S. Pat. Nos. 4,847,655; 4,771,314; 4,833,504; 4,868,608; 4,901,114; 5,061,969; 4,948,686 and 5,171,653, the disclosures of which are totally incorporated herein by reference, full color xerography, and the like. Other suitable photoconductive imaging members include an aluminum based drum photoreceptor.

In embodiments, the developers may be selected for imaging and printing systems with conductive magnetic brush development as illustrated, for example, in U.S. Pat. No. 4,678,734, the disclosure of which is totally incorporated herein by reference, and wherein there is enabled in embodiments high development levels, development to substantially complete neutralization of the photoreceptor image potential, development of low levels of image potentials and increased background suppression.

As explained above, a CMB developer can be used in various systems, for example a hybrid jumping (HJD) system or a hybrid scavengeless development (HSD) system.

In a HJD system, the development roll, better known as the donor roll, is powered by two development fields (potentials across an air gap). The first field is the ac jumping field which is used for toner cloud generation and has a typical potential of 2.6 k volts peak to peak at 3.25 k Hz frequency. The second field is the dc development field which is used to control the amount of developed toner mass on the photoreceptor. It is desirable to eliminate the dc field and use the duty cycle of the ac field to control the toner mass to be developed on the photoreceptor.

HSD technology develops toner via a conventional magnetic brush onto the surface of a donor roll. A plurality of electrode wires is closely spaced from the toned donor roll in the development zone. An AC voltage is applied to the wires to generate a toner cloud in the development zone. This donor roll generally consists of a conductive core covered with a thin, for example 50-200 μm, partially conductive layer. The magnetic brush roll is held at an electrical potential difference relative to the donor core to produce the field necessary for toner development. The toner layer on the donor roll is then disturbed by electric fields from a wire or set of wires to produce and sustain an agitated cloud of toner particles. Typical AC voltages of the wires relative to the donor are 700-900 Vpp at frequencies of 5-15 kHz. These AC signals are often square waves, rather than pure sinusoidal waves. Toner from the cloud is then developed onto the nearby photoreceptor by fields created by a latent image.

The photoconductive imaging devices are generally multilayered photoreceptors that comprise a substrate, an optional conductive layer, an optional undercoat layer, an optional adhesive layer, a charge generating layer, a charge transport layer, and an optional overcoat layer.

The toner/developer disclosed herein when used in a CMB development system significantly reduces the wear rate of the photoreceptor surface. “Significantly” refers to the wear rate decreasing from about 22 nm/kcycles to a wear rate of about 10 nm/kcycles. “Kcycles” refers to 1000 revolutions of the photoreceptor. For reference, a typical photoreceptor that reaches 800 kcycles, i.e., 800,000 cycles, may yield from about 400,000 copies to about 600,000 copies.

The wear rate of the photoreceptor described herein is thus from about −0.004 μm/Kcycles to about −0.018 μm/Kcycles, such as from about −0.004 μm/Kcycles to about −0.0175 μm/Kcycles or from about −0.004 μm/Kcycles to about −0.017 μm/Kcycles. Thus, the developers herein have a photoreceptor wear rating of from about −0.004 to about −0.018.

For comparison, the wear rate of a photoreceptor used with known toners may be greater than −0.018, such as from about −0.02 to about −0.03. Thus, the toner described herein may decrease the wear rate of the photoreceptor by as much as a factor of about 2.2, such as a factor of from about 1.3 to about 2.2.

Illustrative examples of substrate layers selected for the photoreceptors of the present disclosure, and which substrates may be known substrates and which can be opaque or substantially transparent, comprise a layer of insulating material including inorganic or organic polymeric materials, such as MYLAR® a commercially available polymer, MYLAR® containing titanium, a layer of an organic or inorganic material having a semiconductive surface layer, such as indium tin oxide, or aluminum arranged thereon, or a conductive material inclusive of aluminum, chromium, nickel, brass or the like. The substrate may be flexible, seamless, or rigid, and may have a number of many different configurations, such as for example, a plate, a cylindrical drum, a scroll, an endless flexible belt, and the like. In one embodiment, the substrate is in the form of a seamless flexible belt. In some situations, it may be desirable to coat on the back of the substrate, particularly when the substrate is a flexible organic polymeric material, an anticurl layer, such as for example polycarbonate materials commercially available as MAKROLON®.

The thickness of the substrate layer depends on a number of factors, including the characteristics desired and economical considerations, thus this layer may be of substantial thickness, for example over 3,000 microns, such as from about 3,000 to about 7,000 or of minimum thickness, such as at least about 50 microns, providing there are no significant adverse effects on the member. In embodiments, the thickness of this layer is from about 75 microns to about 300 microns.

If a conductive layer is used, it is positioned over the substrate. The term “over” as used herein in connection with many different types of layers, should be understood as not being limited to instances where the layers are continuous. Rather, the term refers to relative placement of the layers and encompasses the inclusion of unspecified intermediate layers.

Suitable materials for the conductive layer include, but are not limited to, aluminum, zirconium, niobiuim, tantalum, vanadium, hafnium, titanium, nickel, stainless steel, chromium, tungsten, molybdenum, copper, and the like, and mixtures and alloys thereof.

The thickness of the conductive layer is, in one embodiment, between about 20 angstroms and about 750 angstroms, and, in another from about 50 angstroms to about 200 angstroms for an optimum combination of electrical conductivity, flexibility, and light transmission. However, the conductive layer can, if desired, be opaque.

The conductive layer can be applied by known coating techniques, such as solution coating, vapor deposition, and sputtering. In embodiments, an electrically conductive layer is applied by vacuum deposition. Other suitable methods can also be used.

If an undercoat layer is employed, it may be positioned over the substrate, but under the charge generating layer. The undercoat layer is at times referred to as a hole-blocking layer in the art.

Suitable undercoat layers for use herein include, but are not limited to, polymers, such as polyvinyl butyral, epoxy resins, polyesters, polysiloxanes, polyamides, polyurethanes, and the like, nitrogen-containing siloxanes or nitrogen-containing titanium compounds, such as trimethoxysilyl propyl ethylene diamine, N-beta(aminoethyl)gamma-aminopropyl trimethoxy silane, isopropyl 4-aminobenzene sulfonyl titanate, di(dodecylbenezene sulfonyl)titanate, isopropyl di(4-aminobenzoyl)isostearoyl titanate, isopropyl tri(N-ethyl amino)titanate, isopropyl trianthranil titanate, isopropyl tri(N,N-dimethyl-ethyl amino)titanate, titanium-4-amino benzene sulfonate oxyacetate, titanium 4-aminobenzoate isostearate oxyacetate, gamma-aminobutyl methyl dimethoxy silane, gamma-aminopropyl methyl dimethoxy silane, and gamma-aminopropyl trimethoxy silane, as disclosed in U.S. Pat. No. 4,338,387, U.S. Pat. No. 4,286,033 and U.S. Pat. No. 4,291,110.

In embodiments, if an undercoat layer is employed, the undercoat layer may be a thick undercoat layer as disclosed in co-pending U.S. Patent Application Publication No. 2006/0057480, which is incorporated herein by reference in its entirety. The undercoat layer may comprise a metallic component and a binder component.

The metallic component may be titanium dioxide or titanium oxide, and the binder component is a phenolic resin, polyester, polyvinyl butyrals, polycarbonates, polystyrene-b-polyvinyl pyridine or polyvinyl formal. The metallic component may be present in the undercoat layer in an amount from about 20 to about 95 weight percent of the undercoat layer. The volume resistivity of the metallic oxide may be from about 10⁴ to about 10¹⁰ Ω·cm under a pressure of about 100 kg/cm² at ambient conditions. If present, the undercoat layer may have a thickness from about 1 micron to about 30 microns.

The undercoat layer may be applied as a coating by any suitable conventional technique such as spraying, die coating, dip coating, draw bar coating, gravure coating, silk screening, air knife coating, reverse roll coating, vacuum deposition, chemical treatment and the like. For convenience in obtaining layers, the undercoat layers may be applied in the form of a dilute solution, with the solvent being removed after deposition of the coating by conventional techniques such as by vacuum, heating and the like. Drying of the deposited coating may be effected by any suitable technique such as oven drying, infrared radiation drying, air drying and the like.

If an undercoat containing micron-size particles is employed, formation of interference patterns known as plywood is reduced. The expression “plywood” refers to the formation of unwanted patterns in electrostatic latent images caused by multiple reflections during exposure of a charged imaging member. These patterns resemble plywood.

In fabricating a photosensitive imaging member, a charge generating layer is deposited and a charge transport layer may be deposited onto the substrate surface either in a laminate type configuration where the charge generating layer and charge transport layer are in different layers or in a single layer configuration where the charge generating layer and charge transport layer are in the same layer along with a binder resin. Photoreceptors in accordance with the present disclosure can be prepared by applying the charge generating layer and a charge transport layer. In embodiments, the charge generating layer and the charge transport layer may be applied in any order.

The charge generating layer is positioned over the undercoat layer. If an undercoat layer is not used, the charge generating layer is positioned over the substrate.

Any suitable polymeric film-forming binder material may be employed as the matrix in the charge generating (photogenerating) binder layer. Typical polymeric film forming materials include those described, for example, in U.S. Pat. No. 3,121,006, the entire disclosure of which is incorporated herein by reference. Thus, typical organic polymeric film forming binders include thermoplastic and thermosetting resins such as polycarbonates, polyesters, polyamides, polyurethanes, polystyrenes, polyarylethers, polyarylsulfones, potybutadienes, polysulfones, polyethersulfones, polyethylenes, polypropylenes, polyimides, polymethylpentenes, polyphenylene sulfides, polyvinyl acetate, polysiloxanes, polyacrylates, polyvinyl acetals, polyamides, polyimides, amino resins, phenylene oxide resins, terephthalic acid resins, phenoxy resins, epoxy resins, phenolic resins, polystyrene and acrylonitrile copolymers, polyvinylchloride, vinylchloride and vinyl acetate copolymers, acrylate copolymers, alkyd resins, cellulosic film formers, poly(amideimide), styrene-butadiene copolymers, vinylidenechloride-vinylchloride copolymers, vinylacetate-vinylidenechloride copolymers, styrene-alkyd resins, polyvinylcarbazole, and the like. These polymers may be block, random or alternating copolymers.

In embodiments, a charge transport layer may be employed. The charge transport layer may comprise a charge-transporting molecule, typically small molecule, dissolved or molecularly dispersed in a film forming electrically inert polymer such as a polycarbonate. The term “dissolved” is defined herein as forming a solution in which the molecules are dissolved in the polymer to form a homogeneous phase. The expression “molecularly dispersed” used herein is defined as a charge transporting small molecule dispersed in the polymer, the small molecules being dispersed in the polymer on a molecular scale.

Any suitable charge transporting or electrically active small molecule may be employed in the charge transport layer of this disclosure. The expression charge transporting “small molecule” is defined herein as a monomer that allows the free charge photogenerated in the generator layer to be transported across the transport layer.

Typical charge transporting molecules include, for example, pyrene, carbazole, hydrazone, oxazole, oxadiazole, pyrazoline, arylamine, arylmethane, benzidinie, thiazole, stilbene and butadiene compounds; pyrazolines such as 1-phenyl-3-(4′-diethylaminostyryl)-5-(4′-diethylamino phenyl)pyrazoline; diamines such as N,N′-diphenyl-N,N′-bis(3-methylphenyl)-(1,1′-biphenyl)-4,4′-diamine; hydrazones such as N-phenyl-N-methyl-3-(9-ethyl)carbazyl hydrazone and 4-diethyl amino benzaldehyde-1,2-diphenyl hydrazone; oxadiazoles such as 2,5-bis(4-N,N′-diethylaminophenyl)-1,2,4-oxadiazole; poly-N-vinylcarbazole, poly-N-vinylcarbazole halide, polyvinyl pyrene, polyvinylanthracene, polyvinylacridine, a pyrene-formaldehyde resin, an ethylcarbazole-formaldehyde resin, a triphenylmethane polymer and polysilane, and the like.

In embodiments, to avoid cycle-up in machines with high throughput, the charge transport layer may be substantially free (less than about two percent) of triphenyl methane. As indicated above, suitable electrically active small molecule charge transporting compounds are dissolved or molecularly dispersed in electrically inactive polymeric film forming materials.

An exemplary small molecule charge transporting compound that permits injection of holes from the pigment into the charge generating layer with high efficiency and transports them across the charge transport layer with very short transit times is N,N′-diphenyl-N,N′-bis(3-methylphenyl)-(1,1′-biphenyl)-4,4′-diamine. If desired, the charge transport material in the charge transport layer may comprise a polymeric charge transport material or a combination of a small molecule charge transport material and a polymeric charge transport material.

In embodiments, the charge transport layer may contain an active aromatic diamine molecule, which enables charge transport, dissolved or molecularly dispersed in a film forming binder. An examplary charge transport layer is disclosed in U.S. Pat. No. 4,265,990, the entire disclosure of which is incorporated herein by reference.

Any suitable electrically inactive resin binder that is also insoluble in the solvent such as alcoholic solvent used to apply the optional overcoat layer may be employed in the charge transport layer. Typical inactive resin binders include polycarbonate resin, polyester, polyarylate, polyacrylate, polyether, polysulfone, and the like. Molecular weights can vary, for example, from about 20,000 to about 150,000. Exemplary binders include polycarbonates such as poly(4,4′-isopropylidene-diphenylene)carbonate (also referred to as bisphenol-A-polycarbonate); polycarbonate: poly(4,4′-cyclohexylidinediphenylene)carbonate (referred to as bisphenol-Z polycarbonate); poly(4,4′-isopropylidene-3,3′-dimethyl-diphenyl)carbonate (also referred to as bisphenol-C-polycarbonate); and the like.

Any suitable charge transporting polymer may also be utilized in the charge transporting layer of this disclosure. The charge transporting polymer should be insoluble in the solvent employed to apply the overcoat layer. These electrically active charge transporting polymeric materials should be capable of supporting the injection of photogenerated holes from the charge generation material and be incapable of allowing the transport of these holes there through.

Any suitable and conventional technique may be utilized to mix and thereafter apply the charge transport layer coating mixture to the charge generating layer. Typical application techniques include spraying, dip coating, roll coating, wire wound rod coating, and the like. Drying of the deposited coating may be effected by any suitable conventional technique such as oven drying, infra red radiation drying, air drying and the like.

Generally, the thickness of the charge transport layer is from about 10 to about 50 micrometers, but thicknesses outside this range can also be used. A hole transport layer should be an insulator to the extent that the electrostatic charge placed on the hole transport layer is not conducted in the absence of illumination at a rate sufficient to prevent formation and retention of an electrostatic latent image thereon. In general, the ratio of the thickness of a hole transport layer to the charge generator layers is typically maintained from about 2:1 to 200:1 and in some instances as great as 400:1. Typically, a charge transport layer is substantially non-absorbing to visible light or radiation in the region of intended use but is electrically “active” in that it allows the injection of photogenerated holes from the photoconductive layer, i.e., charge generation layer, and allows these holes to be transported through itself to selectively discharge a surface charge on the surface of the active layer.

Additionally, adhesive layers can be provided, if necessary, between any of the layers in the photoreceptors to ensure adhesion of any adjacent layers. Alternatively, or in addition, adhesive material can be incorporated into one or both of the respective layers to be adhered. Such optional adhesive layers may have a thickness of about 0.001 micrometer to about 0.2 micrometer. Such an adhesive layer can be applied, for example, by dissolving adhesive material in an appropriate solvent, applying by hand, spraying, dip coating, draw bar coating, gravure coating, silk screening, air knife coating, vacuum deposition, chemical treatment, roll coating, wire wound rod coating, and the like, and drying to remove the solvent. Suitable adhesives include, but are not limited to, film-forming polymers, such as polyester, DuPont 49,000 (available from E. I. DuPont de Nemours & Co.), Vitel PE-100 (available from Goodyear Tire and Rubber Co.), polyvinyl butyral, polyvinyl pyrrolidone, polyurethane, polymethyl methacrylate, and the like.

Optionally, an overcoat layer may also be utilized to improve resistance to abrasion. In some cases, an anti-curl back coating may be applied to the side opposite the photoreceptor to provide flatness and/or abrasion resistance where a web configuration photoreceptor is fabricated. These overcoating and anti-curl back coating layers are well known in the art and may comprise thermoplastic organic polymers or inorganic polymers that are electrically insulating or slightly semi-conductive. Overcoatings are continuous and commercially have a thickness of less than about 10 micrometers.

Optionally, an anti-curl backing layer may be employer to balance the total forces of the layer or layers on the opposite side of the supporting substrate layer. An example of an anti-curl backing layer is described in U.S. Pat. No. 4,654,284, the entire disclosure of which being incorporated herein by reference. A thickness between about 70 and about 160 micrometers is a satisfactory range for flexible photoreceptors.

To remove the toners described herein from the photoconductive imaging member, the development system may include a device to physically remove the toners, for example, a cleaning blade or a cleaning brush. A flexible urethane type cleaning blade may be used to apply pressure against the photoconductive imaging member to prevent toner particles from passing through. Such a flexible blade traps toner particles at the photoreceptor/blade interface, and induces wear on the surface of the photoreceptor as it removes the toner particles.

In embodiments, developers suitable for use in CMB development systems may include the emulsion/aggregation toners disclosed herein, which comprise a wax, a high glass transition temperature (Tg) latex, a gel latex, and a colorant.

Examples of waxes suitable for use herein include aliphatic waxes such as hydrocarbon waxes having about 1 carbon atom to about 30 carbon atoms, such as from about 1 carbon atom to about 30 carbon atoms or from about 1 carbon atom to about 25 carbon atoms, polyethylene, polypropylene or mixtures thereof.

More specific examples of waxes suitable for use herein include polypropylene and polyethylene waxes commercially available from Allied Chemical and Petrolite Corporation, wax emulsions available from Michaelman Inc. and the Daniels Products Company, EPOLENE N-15™ commercially available from Eastman Chemical Products, Inc., VISCOL 550-P™, a low weight average molecular weight polypropylene available from Sanyo Kasei K.K., and similar materials. Commercially available polyethylene waxes possess, it is believed, a molecular weight (Mw) of about 1,000 to about 5,000, and commercially available polypropylene waxes are believed to possess a molecular weight of about 4,000 to about 10,000. Examples of functionalized waxes include amines, amides, for example AQUA SUPERSLIP 6550™, SUPERSLIP 6530™ available from Micro Powder Inc., fluorinated waxes, for example POLYFLUO 190™, POLYFLUO 200™, POLYFLUO 523XF™, AQUA POLYFLUO 411™, AQUA POLYSILK 19™, and POLYSILK 14™ available from Micro Powder Inc., mixed fluorinated, amide waxes, for example MICROSPERSION 19™ also available from Micro Powder Inc., imides, esters, quaternary amines, carboxylic acids or acrylic polymer emulsion, for example JONCRYL 74™, 89™, 130™, 537™, and 538™, all available from SC Johnson Wax, and chlorinated polypropylenes and polyethylenes available from Allied Chemical and Petrolite Corporation and SC Johnson Wax.

In embodiments, the wax comprises a wax in the form of a dispersion comprising, for example, a wax having a particle diameter of from about 100 nanometers to about 500 nanometers, water, and an anionic surfactant. In embodiments, the wax is included in amounts such as from about 2 to about 40 weight percent. The latitude of the wax around about the centerline toner particle formulation may be about 11 weight percent±about 1 weight percent. In embodiments, the wax comprises polyethylene wax particles, such as POLYWAX 850, POLYWAX 750 and POLYWAX 655, commercially available from Baker Petrolite, having a particle diameter in the range of about 100 to about 500 nanometers.

The toner particles disclosed herein also include a high Tg latex.

For example, the high Tg latex comprises latex comprising monomers, such as styrene, butyl acrylate, and beta-carboxyethylacrylate (beta-CEA) monomers prepared, for example, by emulsion polymerization in the presence of an initiator, a chain transfer agent (CTA), and surfactant.

Instead of beta-CEA, the high Tg latex may include any carboxyl acid containing monomer, such as maleic acid, citraconic acid, itaconic acid, alkenyl succinic acid, fumaric acid, mesaconic acid, maleic-acid anhydride, citraconic anhydride, itaconic-acid anhydride, alkenyl succinic-acid anhydride, maleic-acid methyl half ester, maleic-acid ethyl half ester, maleic-acid butyl half ester, citraconic-acid methyl half ester, citraconic-acid ethyl half ester, citraconic-acid butyl half ester, itaconic-acid methyl half ester, alkenyl succinic-acid methyl half ester, fumaric-acid methyl half ester, half ester of the partial saturation dibasic acid such as mesaconic acid methyl half ester, dimethyl maleic acid, the partial saturation dibasic acid ester such as dimethyl fumaric acid, acrylic acid, methacrylic acid, alpha like crotonic acid, cinnamon acid, beta-partial saturation acid, crotonic-acid anhydride, cinnamon acid anhydride, alkenyl malonic acid, a monomer which has an alkenyl glutaric acid, and alkenyl adipic acids.

In embodiments, the high Tg latex comprises styrene:butyl acrylate:beta-CEA wherein, for example, the high Tg latex monomers include from about 70 weight percent to about 90 weight percent styrene, from about 10 weight percent to about 30 weight percent butyl acrylate, and from about 0.05 weight percent to about 10 weight percent beta-CEA.

In embodiments, the toner comprises high Tg latex in an amount of from about 50 weight percent to about 95 weight percent of the total weight of the toner described herein, such as 65 weight percent to about 80 of the total weight of the toner described herein. The latitude of the high Tg latex around about the centerline particle formulation may be about 71 weight percent±about 4 weight percent.

As used herein “centerline toner particle formulation” refers to the ideal formulation of the toner particles disclosed herein. The term “latitude” refers to the variation possible in the formulation while still achieving the features associated with the centerline toner particle formulation.

The high Tg latex disclosed herein that is substantially free of crosslinking and comprises has a crosslinked density less than about 0.1 percent, such as less than about 0.05. As used herein “crosslinked density” refers to the mole fraction of monomer units, which are crosslinking points. For example, in a system where 1 of every 20 molecules is a divinylbenzene and 19 of every 20 molecules is a styrene, only 1 of 20 molecules would crosslink. Thus, in such a system, the crosslinked density would be 0.05.

The onset Tg of the high Tg latex may be from about 53° C. to about 70° C., such as from about 53° C. to about 67° C. or from about 53° C. to about 65° C., or such as about 59° C.

The weight average molecular weight (Mw) of the high Tg latex may be from about 2,000 to about 60,000, such as from about 30,000 to about 40,000, or about 35,000.

The gel latex may be prepared from a high Tg latex, such as a latex comprising monomers of styrene, butyl acrylate, beta-CEA, divinylbenzene, a surfactant and an initiator. Instead of the beta-CEA, the gel latex may include a carboxyl acid containing monomer as described above. The gel latex may be prepared by emulsion polymerization.

In embodiments, the crosslinked density of the gel latex is from about 0.3 percent to about 40 percent, such as from about 0.3 percent to about 35 percent or from about 0.3 percent to about 30 percent crosslinked density.

In embodiments, the toner comprises gel latex in an amount of from about 3 weight percent to about 30 weight percent of the total weight of the toner described herein, such as 5 weight percent to about 15 of the total weight of the toner described herein. The latitude of the gel latex around about the centerline particle formulation may be about 10 weight percent±about 2 weight percent.

Other latexes suitable for preparing the high Tg latex and the gel latex include styrene acrylates, styrene methacrylates, butadienes, isoprene, acrylonitrile, acrylic acid, methacrylic acid, beta-carboxy ethyl acrylate, polyesters, known polymers such as poly(styrene-butadiene), poly(methyl styrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methyl styrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene), poly(styrene-propyl acrylate), poly(styrene-butyl acrylate), poly(styrene-butadiene-acrylic acid), poly(styrene-butadiene-methacrylic acid), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), and the like. In embodiments, the resin or polymer is a styrene/butyl acrylate/beta-carboxyethylacrylate terpolymer.

An initiator suitable for use in producing both the gel latex and the high Tg latex may be, for example, sodium, potassium or ammonium persulfate and may be present with both the crosslinking starting monomers and non-crosslinking starting monomers in the range of from about 0.1 weight percent to about 5 weight percent, such as from about 0.3 weight percent to about 4 weight percent or from about 0.5 weight percent to about 3 weight percent of an initiator based upon the total weight of the monomers. In embodiments, the surfactant may be present in the range of from about 0.3 weight percent to about 10 weight percent, such as from about 0.5 weight percent to about 8 weight percent or from about 0.7 to about 5.0 weight percent of surfactant.

Both the gel latex and the high Tg latex may be produced by similar methods. However, in producing the high Tg latex, no divinylbenzene or similar crosslinking agent is used. Examples of crosslinking agents suitable for making the gel latex include divinylbenzene, divinylnaphthalene, ethylene glycol diacrylate, 1,3-butylene-glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, polyethylene-glycol #400 diacrylate, dipropylene glycol diacrylate, and polyoxyethylene (2)-2,2-bis(4-hydroxyphenyl)propane diacrylate. The gel latex and high Tg latex may be made by any suitable method. One example of a suitable method is described below for illustration.

First, a surfactant solution is prepared by combining a surfactant with water. Surfactants suitable for use herein may be anionic, cationic or nonionic surfactants in effective amounts of, for example, from about 0.01 to about 15, or from about 0.01 to about 5 weight percent of the reaction mixture.

Anionic surfactants include sodium dodecylsulfate (SDS), sodium dodecylbenzene sulfonate, sodium dodecylnaphthalene sulfate, dialkyl benzenealkyl, sulfates and sulfonates, abitic acid, available from Aldrich, NEOGEN R™, NEOGEN SC™ obtained from Kao, and the like.

Examples of cationic surfactants include dialkyl benzene alkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quatemized polyoxyethylalkylamines, dodecyl benzyl triethyl ammonium chloride, MIRAPOL and ALKAQUAT available from Alkaril Chemical Company, SANISOL (benzalkonium chloride), available from Kao Chemicals, SANISOL B-50 available from Kao Corp., which consists primarily of benzyl dimethyl alkonium chloride, and the like.

Examples of nonionic surfactants include polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, available from Rhone-Poulenac as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™.

In a separate container, an initiator solution is prepared. Examples of initiators for the preparation of the latex include water soluble initiators, such as ammonium and potassium persulfates in suitable amounts, such as from about 0.1 to about 8 weight percent, and more specifically, in the range of from about 0.2 to about 5 weight percent. The latex includes both the initial latex and the added delayed latex wherein the delayed latex refers, for example, to the latex portion which is added to the already preformed aggregates in the size range of about 4 to about 6.5 μm, as described below.

In yet another container, a monomer emulsion is prepared by mixing styrene, butyl acrylate, beta-CEA, optionally divinylbenzene if producing the gel latex, and surfactant. In one embodiment, the styrene, butyl acrylate, and/or beta-CEA are olefinic monomers.

Once the preparation of the monomer emulsion is complete, a small portion, for example, about 0.5 to about 5 percent of the emulsion, is slowly fed into a reactor containing the surfactant solution. The initiator solution is then slowly added into the reactor. After about 15 to about 45 minutes, the remainder of the emulsion is added into the reactor.

After about 1 to about 2 hours, but before all of the emulsion is added to the reactor, 1-dodecanethiol or carbon tetrabromide (chain transfer agents that control/limit the length of the polymer chains) is added to the emulsion. In embodiments, the charge transfer agent may be used in effective amounts of, for example, from about 0.05 weight percent to about 15 weight percent of the starting monomers, such as from about 0.1 weight percent to about 13 weight percent or from about 0.1 weight percent to about 10 weight percent of the starting monomers. The emulsion is continued to be added into the reactor.

The monomers may be polymerized under starve fed conditions as referred to in U.S. Pat. No. 6,447,974, incorporated by reference herein in its entirety, to provide latex resin particles having a diameter in the range of from about 20 nanometers to about 500 nanometers, such as from about 75 nanometers to about 400 nanometers or from about 100 to about 300 nanometers.

Colorants or pigments include pigments, dyes, mixtures of pigments and dyes, mixtures of pigments, mixtures of dyes, and the like. In embodiments, the colorant comprises a pigment, a dye, mixtures thereof, carbon black, magnetite, black, cyan, magenta, yellow, red, green, blue, brown, mixtures thereof in an amount of about 1 weight percent to about 25 weight percent by weight based upon the total weight of the toner composition, such as from about 2 weight percent to about 20 weight percent or from about 5 weigh percent to about 15 weight percent based upon the total weight of the toner composition. In embodiments, the latitude of colorant around about a centerline particle formulation is about 8 weight percent±about 0.5 weight percent based upon the total weight of the toner composition. It is to be understood that other useful colorants will become readily apparent to one of skill in the art based on the present disclosure.

In general, useful colorants include Paliogen Violet 5100 and 5890 (BASF). Normandy Magenta RD-2400 (Paul Uhlrich), Permanent Violet VT2645 (Paul Uhlrich), Heliogen Green L8730 (BASF), Argyle Green XP-111-S (Paul Uhlrich), Brilliant Green Toner GR 0991 (Paul Uhlrich), Lithol Scarlet D3700 (BASF), Toluidine Red (Aldrich), Scarlet for Thermoplast NSD Red (Aldrich), Lithol Rubine Toner (Paul Uhlrich), Lithol Scarlet 4440, NBD 3700 (BASF), Bon Red C (Dominion Color). Royal Brilliant Red RD-8192 (Paul Uhlrich), Oracet Pink RF (Ciba Geigy), Paliogen Red 3340 and 3871K (BASF), Lithol Fast Scarlet L4300 (BASF), Heliogen Blue D6840, D7080, K7090, K6910 and L7020 (BASF), Sudan Blue OS (BASF), Neopen Blue FF4012 (BASF), PV Fast Blue B2G01 (American Hoechst), Irgalite Blue BCA (Ciba Geigy), Paliogen Blue 6470 (BASF), Sudan II, III and IV (Matheson, Coleman, Bell), Sudan Orange (Aldrich), Sudan Orange 220 (BASF), Paliogen Orange 3040 (BASF), Ortho Orange OR 2673 (Paul Uhlrich), Paliogen Yellow 152 and 1560 (BASF), Lithol Fast Yellow 0991K (BASF), Paliotol Yellow 1840 (BASF), Novaperm Yellow FGL (Hoechst), Permranerit Yellow YE 0305 (Paul Uhlrich), Lumogen Yellow D0790 (BASF), Suco-Gelb 1250 (BASF), Suco-Yellow D1355 (BASF), Suco Fast Yellow D1165, D1355 and D1351 (BASF), Hostaperm Pink E (Hoechst), Fanal Pink D4830 (BASF), Cinquasia Magenta (DuPont), Paliogen Black L9984 9BASF), Pigment Black K801 (BASF) and particularly carbon blacks such as REGAL 330 (Cabot), Carbon Black 5250 and 5750 (Columbian Chemicals), and the like or mixtures thereof.

Additional useful colorants include pigments in water based dispersions such as those commercially available from Sun Chemical, for example SUNSPERSE BHD 6011X (Blue 15 Type), SUNSPERSE BHD 9312X (Pigment Blue 15 74160), SUNSPERSE BHD 6000X (Pigment Blue 15:3 74160), SUNSPERSE GHD 9600X and GHD 6004X (Pigment Green 7 74260), SUNSPERSE QHD 6040X (Pigment Red 122 73915), SUNSPERSE RHD 9668X (Pigment Red 185 12516), SUNSPERSE RHD 9365X and 9504X (Pigment Red 57 15850:1, SUNSPERSE YHD 6005X (Pigment Yellow 83 21108), FLEXIVERSE YFD 4249 (Pigment Yellow 17 21105), SUNSPERSE YHD 6020X and 6045X (Pigment Yellow 74 11741), SUNSPERSE YHD 600X and 9604X (Pigment Yellow 14 21095). FLEXIVERSE LFD 4343 and LFD 9736 (Pigment Black 7 77226) and the like or mixtures thereof. Other useful water based colorant dispersions include those commercially available from Clariant, for example, HOSTAFINE Yellow GR, HOSTAFINE Black T and Black TS, HOSTAFINE Blue B2G, HOSTAFINE Rubine F6B and magenta dry pigment such as Toner Magenta 6B VP2213 and Toner Magenta EO2 which can be dispersed in water and/or surfactant prior to use.

Other useful colorants include, for example, magnetites, such as Mobay magnetites MO8029, MO8960, Columbian magnetites, MAPICO BLACKS and surface treated magnetites; Pfizer magnetites CB4799, CB5300, CB5600, MCX6369; Bayer magnetites, BAYFERROX 8600, 8610; Northern Pigments magnetites, NP-604, NP-608; Magnox magnetites TMB-100 or TMB-104; and the like or mixtures thereof. Specific additional examples of pigments include phthalocyanine HELIOGEN BLUE L6900, D6840, D7080, D7020, PYLAM OIL BLUE, PYLAM OIL YELLOW. PIGMENT BLUE 1 available from Paul Uhlrich & Company, Inc., PIGMENT VIOLET 1, PIGMENT RED 48, LEMON CHROME YELLOW DCC 1026, E.D. TOLUIDINE RED and BON RED C available from Dominion Color Corporation, Ltd., Toronto, Ontario, NOVAPERM YELLOW FGL, HOSTAPERM PINK E from Hoechst, and CINQUASIA MAGENTA available from E.I. DuPont de Nemours & Company, and the like. Examples of magentas include, for example, 2,9-dimethyl substituted quinacridone and anthraquinone dye identified in the Color Index as CI 60710, CI Dispersed Red 15, diazo dye identified in the Color Index as CI 26050, CI Solvent Red 19, and the like or mixtures thereof. Illustrative examples of cyans include copper tetra(octadecyl sulfonamide)phthalocyanine, x-copper phthalocyanine pigment listed in the Color Index as CI74160, CI Pigment Blue, and Anthrathrene Blue identified in the Color Index as DI 69810, Special Blue X-2137, and the like or mixtures thereof. Illustrative examples of yellows that may be selected include diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,4-dimethoxy acetoacetanilide, and Permanent Yellow FGL. Colored magnetites, such as mixtures of MAPICO BLACK and cyan components may also be selected as pigments.

The toner particles may be made by any known emulsion/aggregation process. An example of such a process suitable for use herein includes forming a mixture of the high Tg latex, the gel latex, wax and colorant, and deionized water in a vessel. The mixture is then stirred using a homogenizer until homogenized and then transferred to a reactor where the homogenized mixture is heated to a temperature of, for example, about 50° C. and held at such temperature for a period of time to permit aggregation of toner particles to the desired size. Once the desired size of aggregated toner particles is achieved, the pH of the mixture is adjusted in order to inhibit further toner aggregation. The toner particles are further heated to a temperature of, for example, about 90° C. and the pH lowered in order to enable the particles to coalesce and spherodize. The heater is then turned off and the reactor mixture allowed to cool to room temperature, at which point the aggregated and coalesced toner particles are recovered and optionally washed and dried.

Dilute solutions of flocculates or aggregating agents may be used to optimize particle aggregation time with as little fouling and coarse particle formation as possible. Examples of flocculates or aggregating agents may include polyaluminum chloride (PAC), dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quatemized polyoxyethylalkylamines, dodecylbenzyl triethyl ammonium chloride, MIRAPOL™ and ALKAQUAT™ (available from Alkaril Chemical Company), SANIZOL™ (benzalkonium chloride) (available from Kao Chemicals), and the like, and mixtures thereof.

In embodiments, the flocculates or aggregating agents may be used in an amount of from about 0.01 weight percent to about 10 weight percent of the toner composition, such as from about 0.02 weight percent to about 5 weight percent or from about 0.05 weight percent to about 2 weight percent. For example, the latitude of flocculates or aggregating agents around about a centerline particle formulation is about 0.17 weight percent±about 0.02 weight percent based upon the total weight of the toner composition.

The emulsion aggregation toner described herein produces a toner particle that is more slippery than other types of toners. The level of wax incorporated into the toner particles may be higher than in other known toner particles, and it is believed that the increased amount of wax in the toner particles increases the ability of the toner particles to lubricant the photoreceptor. In addition, toner particles described herein have a higher level of transfer of toner particles from the photoreceptor to the paper resulting in transfer efficiency levels of greater than about 90 percent, such as in the range of from about 95 percent to about 99.9 percent transfer efficiency. Because the toner described herein is a better lubricate with improved transfer efficiency, there is less toner remaining on the photoreceptor during the cleaning process. Thus, the wear rate of the photoreceptor surface by the friction generated between the cleaning blade and photoreceptor as the residual toner is removed from the surface may be reduced. The majority of the wearing of the photoreceptor occurs at the interface where the cleaning blade removes toner particles from the surface of the photoreceptor.

The size of the formed toner particles may be from about 3 μm to about 8 μm, such as a toner particle size of from about 4.5 μm to about 7 μm or from about 5 μm to about 6 μm.

The circularity may be determined using the known Malvern Sysmex Flow Particle Image Analyzer FPIA-2100. The circularity is a measure of the particles closeness to a perfect sphere. A circularity of 1.0 identifies a particle having the shape of a perfect circular sphere. The toner particles described herein may have a circularity of from about 0.9 to about 1.0, such as from about 0.93 to about 1.0 or from about 0.95 to about 1.0.

The toner particles also preferably have a size such that the upper geometric standard deviation (GSDv) by volume for (D84/D50) is in the range of from about 1.15 to about 1.25, such as from about 1.18 to about 1.23. The particle diameters at which a cumulative percentage of 50% of the total toner particles are attained are defined as volume D50, which are from about 5.45 to about 5.88, such as from about 5.47 to about 5.85. The particle diameters at which a cumulative percentage of 84% are attained are defined as volume D84. These aforementioned volume average particle size distribution indexes GSDv can be expressed by using D50 and D84 in cumulative distribution, wherein the volume average particle size distribution index GSDv is expressed as (volume D84/volume D50). The upper GSDv value for the toner particles indicates that the toner particles are made to have a very narrow particle size distribution.

The developed toner mass per unit area (TMA) suitable for the printed images from the toner described herein may be in the range of from about 0.35 mg/cm² to about 0.55 mg/cm², such as from about 0.4 mg/cm² to 0.5 about mg/cm² or from about 0.43 mg/cm² to about 0.47 mg/cm².

It may also be desirable to control the toner particle size and limit the amount of both fine and coarse toner particles in the toner. The toner particles may have a very narrow particle size distribution with a lower number ratio geometric standard deviation (GSDn), which is express as (number D50/number D16), of from about 1.20 to about 1.30, such as from about 1.22 to about 1.29.

The toner particles disclosed herein are disclosed in copending U.S. patent application Ser. No. 11/610,291, filed Dec. 13, 2006, which is incorporated herein by reference in its entirety.

The toner particles described herein may include external additives. Such external additives may be additives that associate with the surface of the toner particles. In the present disclosure, the external additives include at least one of silicon dioxide or silica (SiO₂), or titania or titanium dioxide (TiO₂). In general, silica is applied to the toner surface for toner flow, triboelectric enhancement, admix control, improved development and transfer stability and higher toner blocking temperature. TiO₂ is applied for improved relative humidity (RH) stability, triboelectric control and improved development and transfer stability. In embodiments, the external additive package includes both silica and titania.

The SiO₂ and TiO₂ may have a primary particle size of less than 200 nm. The silica may have a primary particle size in the range about 5 to about 200 nm. The titania may have a primary particle size in the range about 5 to about 50 nm. Of course, larger size particles may also be used, if desired, for example up to about 500 nm. TiO₂ is found to be especially helpful in maintaining development and transfer over a broad range of area coverage and job run length. The SiO₂ and TiO₂ may be applied to the toner surface with the total coverage of the toner ranging from about 50 percent to about 200 percent surface area coverage (SAC). Another metric relating to the amount and size of the additives is “SAC×Size” ((percentage surface area coverage) times (the primary particle size of the additive in nanometers)), for which the additives may have a total SAC×Size range from about 1,000 to about 4,000.

In embodiments, the SiO₂ added may be surface treated with polydimethylsiloxane, such as RY50 available from Nippon Aerosil. Other suitable treated fumed silicas are commercially available as TS530 from Cabot Corporation, Cab-O-Sil Division. The titania may be either treated or untreated. Untreated titanium dioxide is available as P25 from Degussa. The titanium dioxide may be surface treated, for example with a decylsilane which is commercially available as MT3103, or as SMT5103, both available from Tayca Corporation.

At least two metal stearate external additives selected from the group consisting of zinc stearate, calcium stearate, aluminum stearate and magnesium stearate may also be present on the toners. The metal stearates provide lubricating properties. Due to their lubricating nature, metal stearates also provide triboelectric enhancement. Furthermore, metal stearates enable higher toner charge and charge stability by increasing the number of contacts between toner and carrier particles. One commercially available metal stearate is zinc stearate, having a particle size such that 100% of the material passes through a 325 mesh screen, is known as ZINC STEARATE L™ made by Ferro Corporation, Polymer Additives Division. Other commercially available zinc stearates, such as those available from Synthetic Products.

No single metal stearate can provide all of the desired performance attributes, which frequently leads to some trade-off in performance. For example, U.S. Pat. No. 6,416,916 shows that higher amounts of zinc stearate result in the occurrence of image depletion defects appearing in solid area images, particularly during long print runs. Thus, the amount of zinc stearate in that example must be limited to less than 0.1 percent loading in the toner.

It has been found that if at least two metal stearates are part of the external additives, various benefits are achieved in the CMB system. In particular, in the HSD development system, by adding more than one metal stearate as an external additive selected from the group consisting of zinc stearate, calcium stearate, aluminum stearate and magnesium stearate to the toner, an excellent combination of the desired performance attributes, such as charge level, charge stability, RH sensitivity, admix, charge-through, charge distribution widths, and developer conductivity, can be achieved. In embodiements, the external additives may include aluminum stearate and calcium stearate.

The metal stearates may be present in the toner particles in an amount of from about 0.025 percent to about 5.0 percent by weight of the toner particles, such as from about 0.05 percent to about 3 percent by weight of the toner particles. When using two metal stearates, the ratio of the two metal stearates may range from about 4:1 to about 1:1, such as from about 2:1 to about 1:1 or such as about 1:1.

Illustrative examples of carrier particles that may be selected for mixing with the toner composition prepared in accordance with the present disclosure include those particles that are capable of turboelectrically obtaining a charge of opposite polarity to that of the toner particles. Illustrative examples of suitable carrier particles include granular zircon, granular silicon, glass, steel, nickel, ferrites, iron ferrites, silicon dioxide, and the like. Additionally, there can be selected as carrier particles nickel berry carriers as disclosed in U.S. Pat. No. 3,847,604, the entire disclosure of which is hereby totally incorporated herein by reference, comprised of nodular carrier beads of nickel, characterized by surfaces of reoccurring recesses and protrusions thereby providing particles with a relatively large external area. Other carriers are disclosed in U.S. Pat. Nos. 4,937,166 and 4,935,326, the disclosures of which are hereby totally incorporated herein by reference.

In embodiments, the carrier may be is comprised of atomized steel available commercially from, for example, Hoeganaes Corporation.

The selected carrier particles can be used with or without a coating, the coating generally being comprised of fluoropolymers, such as polyvinylidene fluoride resins, terpolymers of styrene, methyl methacrylate, a silane, such as triethoxy silane, tetrafluorethylenes, other known coatings and the like.

In another embodiment, the carrier core is partially coated with a polymethyl methacrylate (PMMA) polymer having a weight average molecular weight of 300,000 to 350,000 commercially available from Soken. The PMMA is an electropositive polymer in that the polymer that will generally impart a negative charge on the toner with which it is contacted.

The PMMA may optionally be copolymerized with any desired comonomer, so long as the resulting copolymer retains a suitable particle size. Suitable comonomers can include monoalkyl, or dialkyl amines, such as a dimethylaminoethyl methacrylate, diethylaminoethyl methacrylate, diisopropylaminoethyl methacrylate, or t-butylaminoethyl methacrylate, and the like.

In yet another embodiment, the polymer coating of the carrier core may be comprised of PMMA, such as PMMA applied in dry powder form and having an average particle size of less than 1 micrometer, such as less than 0.5 micrometers, which is applied (melted and fused) to the carrier core at higher temperatures on the order of 220° C. to 260° C. Temperatures above 260° C. may adversely degrade the PMMA. Triboelectric tunability of the carrier and developers herein is provided by the temperature at which the carrier coating is applied, higher temperatures resulting in higher tribo up to a point beyond which increasing temperature acts to degrade the polymer coating and thus lower tribo.

The toner to carrier ratio in the developer described herein may be from about 3.0 to about 5.5, such as from about 4.0 to about 5.0 or about 4.5.

The toners and developers disclosed herein may be used in xerographic devices that have a variety of process speeds. Such devices may have process speeds from about 170 mm/sec to about 400 mm/sec, such as from about 180 mm/sec to about 390 mm/sec or from about 190 mm/sec to about 380 mm/sec. The print speed of the xerographic devices may be from about 20 ppm to about 110 ppm, such as from about 25 ppm to about 100 ppm or from about 30 ppm to about 90 ppm. In embodiments, the print speed may be about 35 ppm, about 38 ppm, about 45 ppm, about 55 ppm, about 75 ppm or about 87 ppm.

Embodiments described above will now be further illustrated by way of the following examples.

### EXAMPLE 1

### Preparation of Toner Particles A with 10.5% Polywax 655

The EA particles were prepared by mixing together about 278.5 kilograms of High Tg Latex having a solids loading of about 41.57 weight percent, about 92.41 kilograms of POLYWAX 655® wax emulsion having a solids loading of about 30.28 weight percent, about 130.55 kilograms of a black pigment dispersion Cavitron PD-K125 (Regal 330) having a solids loading of about 17.08 weight percent, about 104.0 kilograms of a Gel Latex having a solids content of about 25 weight percent with about 831.7 kilograms of de-ionized water in a vessel while being stirred using an IKA Ultra Turrax® T50 homogenizer operating at about 4,000 rpm.

After 30 minutes of homogenizing, slow controlled addition of about 44.2 kilograms of a flocculent mixture containing about 4.42 kilograms polyaluminum chloride mixture and about 39.78 kilograms of about 0.02 molar nitric acid solution was performed. The reactor jacket temperature was set to about 57° C. and the particles aggregated to a target size of about 4.8 micron as measured with a Multisizer.

Upon reaching about 4.8 micron, additional amounts of about 179.3 kilograms of the High Tg Latex were added and the particles grew to the target particle size of about 5.85 to about 5.90 microns. The particle size was frozen by adjusting the reactor mixture pH to about 6.0 with about 1 molar sodium hydroxide solution. Thereafter, the reactor mixture was heated at about 0.375° C. per minute to a temperature of about 85° C., followed by adjusting the reactor mixture pH to about 3.9 with about 0.3 M nitric acid solution. The reaction mixture was then ramped to about 96° C. at about 0.375° C. per minute.

At the start of particle coalescence, the pH was checked but not adjusted. The particle shape was monitored by measuring particle circularity using the Sysmex FPIA shape analyzer. Once the target circularity of about 0.958 was achieved, the pH was adjusted to about 7.0 with about 1 percent sodium hydroxide solution. Particle coalescence was continued for a total of about 2.5 hours at about 96° C. The particles were cooled to about 63° C. At about 63° C., the slurry was treated with about 4 percent sodium hydroxide solution to pH of about 10 for about 20 minutes followed by cooling to about room temperature.

The toner of this mixture comprises about 71.5 percent of styrene/acrylate polymer, about 8 percent of Regal 330 pigment, about 10.5 percent by weight of Polywax 655 and about 10 per ent by weight of the Gel Latex.

The particles were washed 3 times after removal of the mother liquor consisting of 1 wash with de-ionized water at about room temperature, one wash carried out at a pH of about 4.0 at about 40° C., and finally the last wash with de-ionized water at about room temperature. The amount of about 0.3 molar nitric acid used for the pH 4 wash was about 30 grams per kilogram of particles.

After drying the particles in an Aljet dryer, the final average particle size D50=5.95 microns, GSDv of about 1.20, GSDn of about 1.25, percent fines (<4.0 microns) of about 12.8% and particle circularity of about 0.962.

The surface additive package blended onto the particles consisted of about 0.74 weight percent of X-24 which is a type of silica (silica A, about 1.11 weight percent of titanium dioxide and about 1.71 weight percent of silica type B. This toner was then blended with a carrier to produce the developer that was used to generate prints and to determine the photoreceptor wear rate with EA toner.

### EXAMPLE 2

### Preparation of Toner Particles B with 9% Polywax 725

The EA particles were prepared by mixing together about 166.2 kilograms of High Tg Latex having a solids loading of 41.57 weight percent, 45.70 kilograms of a POLYWAX 725® wax emulsion having a solids loading of about 30.28 weight percent, about 75.32 kilograms of black pigment dispersion CAVITRON PD-K125 (Regal 330) having a solids loading of about 17.08 weight percent, abpit 60.0 kilograms of Gel Latex having a solids content of about 25 weight percent with about 481.9 kilograms of de-ionized water in a vessel while being stirred using an IKA Ultra Turrax® T50 homogenizer operating at about 4,000 rpm.

After about 30 minutes of homogenizing, slow controlled addition of about 25.5 kilograms of a flocculent mixture containing about 2.55 kilograms polyaluminum chloride mixture and about 22.95 kilograms of about 0.02 molar nitric acid solution was performed. The reactor jacket temperature was set to about 57° C. and the particles aggregated to a target size of about 4.8 micron.

Upon reaching about 4.8 micron, about an additional 103.44 kilograms of High Tg Latex was added and the particles grew to the target particle size of from about 5.85 to about 5.9 microns. The particle size was frozen by adjusting the reactor mixture pH to about 6.0 with about 1 molar sodium hydroxide solution. Thereafter, the reactor mixture was heated at about 0.375° C. per minute to a temperature of about 85° C., followed by adjusting the reactor mixture pH to about 3.9 with about 0.3 M nitric acid solution. The reaction mixture was then ramped to about 96° C. at about 0.375° C. per minute.

At the start of particle coalescence, the pH was checked but not adjusted. The particle shape was monitored by measuring particle circularity using the Sysmex FPIA shape analyzer. Once the target circularity of 0.958 was achieved, the pH was adjusted to about 7.0 with about 1 percent sodium hydroxide solution. Particle coalescence was continued for a total of about 5 hours at about 96° C. The particles were cooled to about 63° C.

At about 63° C., the slurry was treated with about 4 percent sodium hydroxide solution to a pH of about 10 for about 20 minutes followed by cooling to about room temperature.

The toner of this mixture comprised about 73 percent of styrene/acrylate polymer, about 8 percent of Regal 330 pigment, about 9 percent by weight of POLYWAX 725 and about 10 per cent by weight of Gel Latex.

The particles were washed about 5 times after removal of the mother liquor consisting of about 3 washes with de-ionized water at about room temperature, one wash carried out at a pH of about 4.0 at about 40° C., and finally the last wash with de-ionized water at about room temperature. The amount of about 0.3 molar nitric acid used for the pH 4 wash was about 20 grams per kilogram of particles.

After drying the particles in an Aljet dryer, the final average particle size D50=5.60 microns, GSDv of about 1.21, GSDn of about 1.26, percent fines (<4.0 microns) of about 19.0 percent and particle circularity of about 0.956.

The surface additive package blended onto the particles consisted of about 0.74 weight percent of X-24 silica type A, about 1.11 weight percent of titanium dioxide and about 1.71 weight percent of silica type B. This toner was then blended with a carrier to produce the developer that was used to generate prints in the test and to determine the photoreceptor wear rate with EA toner.

Results

| | | | Photoreceptor | Improvement of |
|---|---|---|---|---|
| | | | CTL Thickness | Wear Rate with |
| | | | Wear Rate | Presently Disclosed |
| Toners | Print Speed | | (μm/Kcycles) | EA Toner |
| Known | 45/55 | PPM | −0.0217 | — |
| Mechanically Made | 56/75 | PPM | −0.0186 | — |
| Toner | | | | |
| Example 2 Toner | 95 | PPM | −0.0058 | 2.2 times |
| Example 1 Toner | 75/87 | PPM | −0.011 | 1.3 times |
| | 45/55 | PPM | −0.0109 | 2 times |
| | 35 | PPM | −0.0163 | 1.7 times |

As summarized in Table 1, the reduction in photoreceptor surface wear rate when small size EA toners (about 5.7 microns) are substituted for the much larger conventional toner (about 8.9 microns). With EA toner the reduction in the CTL thickness is significantly decreased anywhere from 1.3 times at the slower print speeds up to as much as 2.2 times at the faster speeds. For a photoreceptor with a target life of over 400,000 prints a decrease in the wear by 2 fold will enable the life of the photoreceptor to increase by 2-fold. Thus, extending the life of the photoreceptor and having an impact on the total costs. Another benefit of low wearing photoconductive surfaces is a more stable image quality as the xerographic set points are less sensitive to aging effects.

It will be appreciated that in various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

What is claimed is:

1. An electrophotographic image forming apparatus comprising a photoreceptor, a conductive magnetic brush development system, and a housing in association with the conductive magnetic brush development system for a developer comprising a toner composition having emulsion/aggregation toner particles comprising a gel latex, a high Tg latex, a wax, and a colorant,
wherein the gel latex is present in an amount of from about 3 weight percent to about 30 weight percent of the toner composition, the high Tg latex is present in an amount of from about 50 weight percent to about 95 weight percent of the toner composition, the wax is present in an amount of from about 2 weight percent to about 40 weight percent of the toner composition, and the colorant is present in an amount of from about 1 weight percent to about 25 weight percent of the toner composition.

2. The electrophotographic image forming apparatus according to claim 1, wherein a latitude of the gel latex around about a centerline toner particle formulation is about 10 weight percent±about 2 weight percent, a latitude of the high Tg latex around about a centerline particle formulation is about 71 weight percent±about 4 weight percent, a latitude of the wax around about a centerline toner particle formulation is about 11 weight percent±about 1 weight percent, and a latitude of the colorant around about a centerline toner particle formulation is about 8 weight percent±about 0.5 weight percent.

3. The electrophotographic image forming apparatus according to claim 1, wherein the toner composition further includes a flocculant, and wherein a latitude of the flocculent around about a centerline particle formulation is about 0.17 weight percent±about 0.02 weight percent.

4. The electrophotographic image forming apparatus according to claim 1, wherein a crosslinked density of the gel latex is from about 0.3 to about 40, and a crosslinked density of the high Tg latex is less than about 0.1.

5. The electrophotographic image forming apparatus according to claim 1, wherein the apparatus further includes a cleaning device to remove the toner particles from the photoreceptor surface.

6. The electrophotographic image forming apparatus according to claim 5, wherein the cleaning device is a cleaning blade.

7. The electrophotographic image forming apparatus according to claim 1, wherein the photoreceptor has a wear rate of from about −0.004 μm/Kcycles to about −0.018 μm/Kcycles.

8. The electrophotographic image forming apparatus according to claim 1, wherein the toner particles provide an improved wear rate of from about 1.3 to about 2.2.

9. The electrophotographic image forming apparatus according to claim 1, wherein the toner particles include at least one external additive.

10. The electrophotographic image forming apparatus according to claim 9, wherein the at least one external additive comprises a metal.

11. The electrophotographic image forming apparatus according to claim 1, wherein the developer further comprises a carrier.

12. A developer comprising a carrier and an emulsion/aggregation toner, wherein the toner comprises a gel latex, a high Tg latex, a wax, and a colorant,
wherein the gel latex is present in an amount of from about 3 weight percent to about 30 weight percent of the toner, the high Tg latex is present in an amount of from about 50 weight percent to about 95 weight percent of the toner, the wax is present in an amount of from about 2 weight percent to about 40 weight percent of the toner, and the colorant is present in an amount of from about 1 weight percent to about 25 weight percent of the toner, and
wherein the developer is capable of reducing photoreceptor wear in a conductive magnetic brush development system.

13. The developer according to claim 12, wherein a latitude of the gel latex around about a centerline toner particle formulation is about 10 weight percent±about 2 weight percent.

14. The developer according to claim 12, wherein a latitude of the high Tg latex around about a centerline particle formulation is about 71 weight percent±about 4 weight percent.

15. The developer according to claim 12, wherein a latitude of the wax around about a centerline toner particle formulation is about 11 weight percent±about 1 weight percent.

16. The developer according to claim 12, wherein a latitude of the colorant around about a centerline toner particle formulation is about 8 weight percent±about 0.5 weight percent.

17. The developer according to claim 12, wherein a crosslinked density of the gel latex is from about 0.3 to about 40, and a crosslinked density of the high Tg latex is less than about 0.1.

18. A method of printing a toner based image, comprising:
charging a photoreceptor to a uniform potential,
exposing the charged photoreceptor surface to a light image in order to record an electrostatic latent image onto the surface of the photoreceptor,
developing the electrostatic latent image by bringing a developer in contact with the electrostatic latent image to expose an image,
transferring the image to a substrate to form a toner-based image, and
fusing the toner-based image to the substrate,
wherein the developer comprises an emulsion/aggregation toner having a gel latex, a high Tg latex, a wax, and a colorant,
wherein residual toner is removed from the photoreceptor surface with a cleaning device, and
wherein the wear rate of the photoreceptor is from about −0.004 μm/Kcycles to about −0.018 μm/Kcycles.

19. The method according to claim 18, wherein the developer further comprises a carrier.

20. The method according to claim 18, wherein the developing occurs in wigh conductive magnetic brush development system.

21. The method according to claim 18, wherein the cleaning device is a cleaning blade.

22. A developer comprising a carrier and a toner, wherein the developer has a photoreceptor wear rate rating of from about 0.004 μm/Kcycles to about −0.018 μm/Kcycles.
